(19) United States
(12) Patent Application Publication
(10) Pub. No.: US 2005/0289514 A1
(43) Pub. Date: Dec. 29, 2005

(54) Multi-view history mark with cycle-specific display

(76) Inventors: Donald F. Hooper, Shrewsbury, MA (US); Eric Walker, Lancaster, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/877,486

(22) Filed: Jun. 25, 2004

(51) Int. Cl. G06F 9/44

(52) U.S. Cl. 717/124

(57) ABSTRACT

A debugger tool that enables a user to set history marks at selected points in time in a simulation history and to navigate the history marks.

### BACKGROUND

With each new generation of network processors, hardware architecture becomes more complex, e.g., with the addition of processing elements, memory controllers, hardware acceleration co-processors, and other features. Thus, the need to simplify the code debugging processes is greater than ever before. Debugger tools to date provide a visual simulation environment with views of multiple processing elements and multiple hardware execution threads.

### DESCRIPTION OF DRAWINGS

FIG. 1 is a block diagram of a system having a processor with microengines that support multiple threads of execution.

FIG. 2 is a block diagram that shows an exemplary architecture of the microengine (ME).

FIGS. 3A-3B show an exemplary ME task assignment for a software pipeline model of the processor (from FIGS. 1-2) programmed to run a particular network application.

FIG. 4 is an exemplary environment in which a development/debugging system is usable to debug microcode to be executed by ME threads.

FIG. 5 is a block diagram illustrating various components of the development/debugger system (from FIG. 4) according to an exemplary embodiment.

FIG. 6 is a depiction of an exemplary GUI code list view and GUI thread history view.

FIG. 7 is a depiction of an exemplary data structure layout of a per-ME Instruction Operand Map.

FIG. 8 is a depiction of an exemplary layout of a per-ME program count (PC) history (of the simulation history shown in FIGS. 4 and 5).

FIG. 9 is a depiction of an exemplary layout of a per-ME, per-register register history (of the simulation history shown in FIGS. 4 and 5).

FIG. 10 is a depiction of an exemplary layout of a per-ME memory reference history (of the simulation history shown in FIGS. 4 and 5).

FIG. 11 is a depiction of an exemplary layout of a packet status list of a packet history shown in FIG. 5).

FIG. 12 is a depiction of an exemplary layout of a packet event list (of the packet history shown in FIG. 5).

FIG. 13 is a depiction of an exemplary GUI packet list view.

FIG. 14 is a depiction of an exemplary GUI packet event view.

FIG. 15 is a depiction of an exemplary GUI packet dataflow view.

FIG. 16 is a depiction of an exemplary GUI view that supports use of history marks.

FIG. 17 is an illustration showing the relationship between marked cycles in a history marks list and different GUI views in which the marked cycles may be presented.

FIGS. 18A-18B are flow diagrams illustrating exemplary processes for adding and removing history marks.

FIG. 19 is a diagram illustrating a sample computer system suitable to be programmed with embodiments of the development/debugger system of FIGS. 4-5.

Like reference numerals will be used to represent like elements.

### DETAILED DESCRIPTION

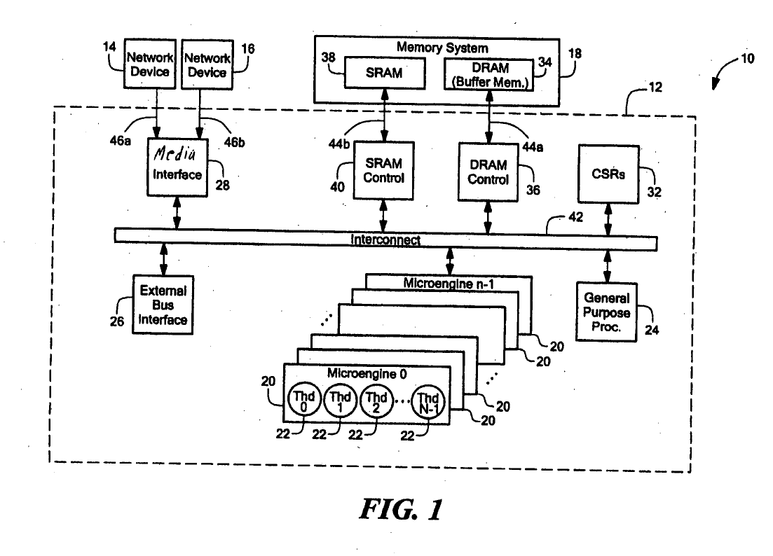

Referring to FIG. 1, a system 10 includes a processor 12 coupled to one or more I/O devices, for example, network devices 14 and 16, as well as a memory system 18. The processor 12 includes multiple processors (“microengines” or “MEs”) 20, each with multiple hardware controlled execution threads 22. In the example shown, there are “n” microengines 20, and each of the microengines 20 is capable of processing multiple threads 22, as will be described more fully below. In the described embodiment, the maximum number “N” of threads supported by the hardware is eight. Each of the microengines 20 is connected to and can communicate with adjacent microengines.

In one embodiment, the processor 12 also includes a processor 24 that assists in loading microcode control for the microengines 20 and other resources of the processor 12, and performs other general-purpose computer type functions such as handling protocols and exceptions. In network processing applications, the processor 24 can also provide support for higher layer network processing tasks that cannot be handled by the microengines 20.

The microengines 20 each operate with shared resources including, for example, the memory system 18, an external bus interface 26, a media interface 28 and Control and Status Registers (CSRs) 32. The media interface 28 is responsible for controlling and interfacing the processor 12 to the network devices 14, 16. The memory system 18 includes a Dynamic Random Access Memory (DRAM) 34, which is accessed using a DRAM controller 36 and a Static Random Access Memory (SRAM) 38, which is accessed using an SRAM controller 40. Although not shown, the processor 12 also would include a nonvolatile memory to support boot operations. The DRAM 34 and DRAM controller 36 are typically used for processing large volumes of data, e.g., in network applications, processing of payloads from network packets. In a networking implementation, the SRAM 38 and SRAM controller 40 are used for low latency, fast access tasks, e.g., accessing look-up tables, storing buffer descriptors and free buffer lists, and so forth.

The devices 14, 16 can be any network devices capable of transmitting and/or receiving network traffic data, such as framing/MAC devices, e.g., for connecting to 10/100BaseT Ethernet, Gigabit Ethernet, ATM or other types of networks, or devices for connecting to a switch fabric. For example, in one arrangement, such as a network forwarding device line card, the network device 14 could be an Ethernet MAC device (connected to an Ethernet network, not shown) that transmits data to the processor 12 and device 16 could be a switch fabric device that receives processed data from processor 12 for transmission onto a switch fabric.

In addition, each network device 14, 16 can include a plurality of ports to be serviced by the processor 12. The media interface 28 therefore supports one or more types of interfaces, such as an interface for packet and cell transfer between a PHY device and a higher protocol layer (e.g., link layer), or an interface between a traffic manager and a switch fabric for Asynchronous Transfer Mode (ATM), Internet Protocol (IP), Ethernet, and similar data communications applications. The media interface 28 may include separate receive and transmit blocks, and each may be separately configurable for a particular interface supported by the processor 12.

Other devices, such as a host computer and/or bus peripherals (not shown), which may be coupled to an external bus controlled by the external bus interface 26 can also serviced by the processor 12.

In general, as a network processor, the processor 12 can interface to any type of communication device or interface that receives/sends data. The processor 12 functioning as a network processor could receive packets from a network device like network device 14 and process those packets in a parallel manner. The term “packet” as used herein may refer to an entire network packet (e.g., Ethernet packet) or a portion of such a network packet, e.g., a cell such as a Common Switch Interface (or “CSIX”) cell or ATM cell, as well as other units of information.

Each of the functional units of the processor 12 is coupled to an internal bus structure or interconnect 42. Memory busses 44a, 44b couple the memory controllers 36 and 40, respectively, to respective memory units DRAM 34 and SRAM 38 of the memory system 18. The I/O Interface 28 is coupled to the devices 14 and 16 via separate I/O bus lines 46a and 46b, respectively.

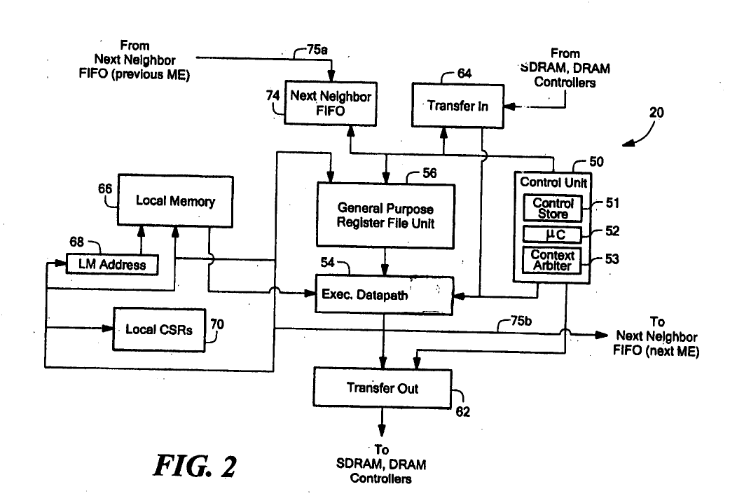

Referring to FIG. 2, an exemplary microengine (ME) 20 is shown. The ME 20 includes a control unit 50 that includes a control store 51, control logic (or microcontroller) 52 and a context arbiter/event logic 53. The control store 51 is used to store microcode. The microcode is loadable by the processor 24. The functionality of the ME threads 22 is therefore determined by the microcode loaded via the processor 24 for a particular user's application into the microengine's control store 51.

The microcontroller 52 includes an instruction decoder and program count (PC) units for each of the supported threads. The context arbiter/event logic 53 can receive messages from any of the shared resources, e.g., SRAM 38, DRAM 34, or processor core 24, and so forth. These messages provide information on whether a requested function has been completed.

The ME 20 also includes an execution datapath 54 and a general purpose register (GPR) file unit 56 that is coupled to the control unit 50. The GPRs are read and written exclusively under program control. The GPRs, when used as a source in an instruction, supply operands to the datapath 54. When used as a destination in an instruction, they are written with the result of the datapath 54. The instruction specifies the register number of the specific GPRs that are selected for a source or destination. Opcode bits in the instruction provided by the control unit 50 select which datapath element is to perform the operation defined by the instruction.

The ME 20 further includes write transfer (transfer out) register file 62 and a read transfer (transfer in) register file 64. The write transfer registers of the write transfer register file 62 store data to be written to a resource external to the microengine. In the illustrated embodiment, the write transfer register file is partitioned into separate register files for SRAM and DRAM. The read transfer register file 64 is used for storing return data from a resource external to the microengine 20. Like the write transfer register file, the read transfer register file is divided into separate register files for SRAM and DRAM. The transfer register files 62, 64 are connected to the datapath 54, as well as the control store 50. The architecture of the processor 12 supports “reflector” instructions that allow any ME to access the transfer registers of any other ME.

Also included in the ME 20 is a local memory 66. The local memory 66, addressed by registers 68, supplies operands to the datapath 54 and receives results from the datapath 54 as a destination.

The ME 20 also includes local control and status registers (CSRs) 70, coupled to the transfer registers, for storing local inter-thread and global event signaling information, as well as other control and status information. Other storage and functional units may be included in the ME 20 as well.

Other register types of the ME 20 include next neighbor (NN) registers 74, coupled to the control store 50 and the execution datapath 54, for storing information received from a previous neighbor ME (“upstream ME”) in pipeline processing over a next neighbor input signal 76a, or from the same ME, as controlled by information in the local CSRs 70. A next neighbor output signal 76b to a next neighbor ME (“downstream ME”) in a processing pipeline can be provided under the control of the local CSRs 70. Thus, a thread on any ME can signal a thread on the next ME via the next neighbor signaling.

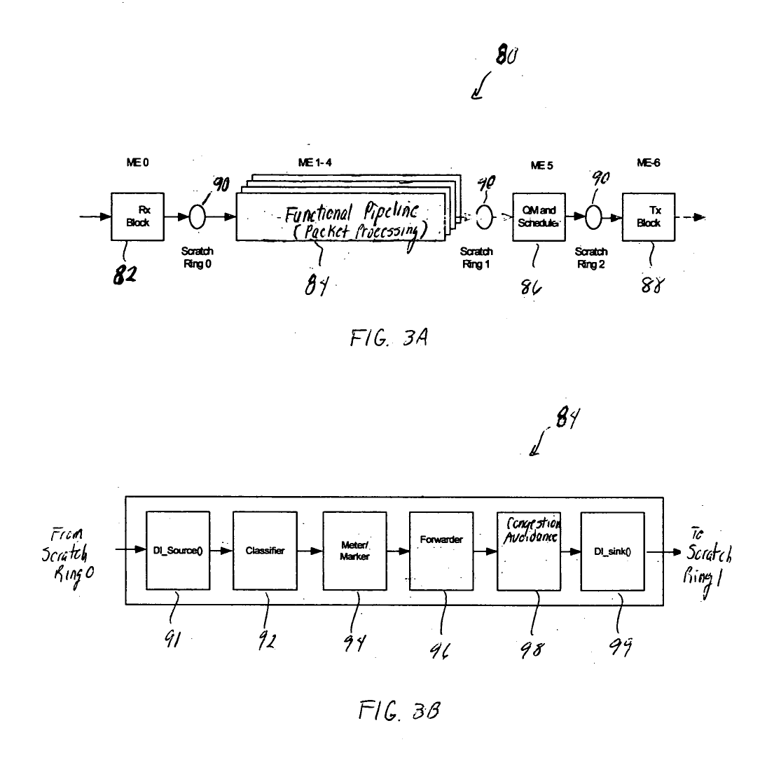

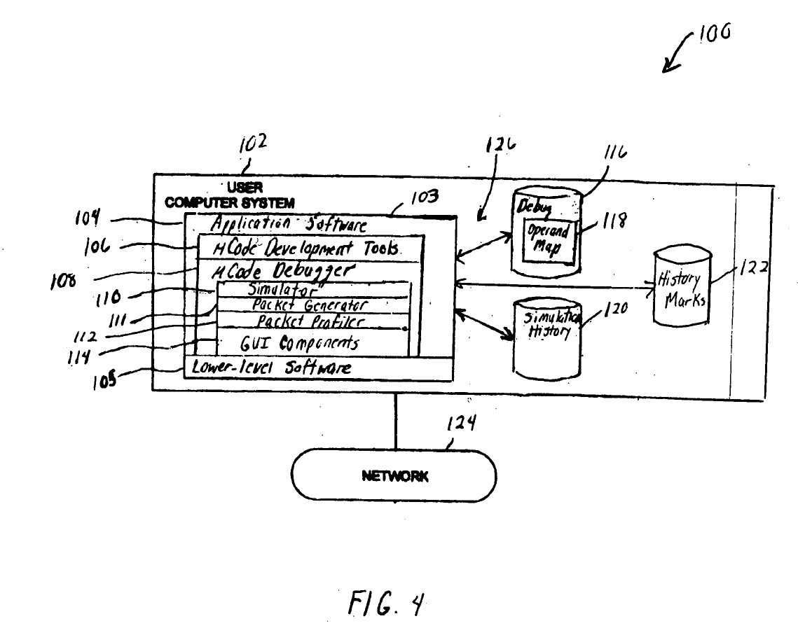

The functionality of the microengine threads 22 is determined by microcode loaded (via the general purpose processor or “GPP” 24) for a particular user's application into each microengine's control store 51. Referring to FIG. 3A, an exemplary ME task assignment for a software pipeline model 80 of the processor 12 programmed to run a particular network application is shown. The task assignment may be represented in terms of “microblocks”. A microblock is a block of ME microcode that reflects a high-level partitioning in the application. In the illustrated ME task assignment, the processor 12 supports the following: a receive (“Rx”) microblock 82 which executes on single microengine (ME 0); a functional pipeline 84 of multiple microblocks (that perform packet processing, e.g., such operations as packet classification, packet forwarding, differentiated services or “Diffserv” processing), which runs on four MEs (shown as MEs 1 through 4); a queue manager and scheduler microblock 86 which executes on a sixth ME (ME 5); and a transmit (“Tx”) microblock 88 which executes on a seventh ME (ME 6). The single microblock ME stages (e.g., microblocks 82, 88) are referred to as context pipestages. Scratch rings 90 are used to pass information between context pipestages, and to pass information between context pipestages and functional pipelines.

In one embodiment, as shown in FIG. 3B, the functional pipeline 84 involves the execution of the following microblocks: a source (“d1_source[ ]”) microblock 91, a classifier microblock 92, a meter microblock 94, a forwarder microblock 96; a congestion avoidance (CA) microblock 98; and a sink (“d1_sink[ ]”) microblock 99. In the illustrated example, the source microblock 91 reads data unit from the scratch ring 0. At the end of CA microblock processing, the block d1_sink[ ] microblock 99 enqueues information based on the results of the functional pipeline processing to the downstream scratch ring 1.

Collectively, the stages 91, 92, 94, 96, 98 and 99 form a functional pipeline, as noted earlier. The functional pipeline runs on four MEs in parallel, and each of the eight threads (threads 0 through 7) in each ME is assigned a different packet for processing.

FIG. 4 shows an integrated development/debugger system environment 100 that includes a user computer system 102. The user computer system 102 is configured to debug a network processor application developed for use by a target network processor. The network processor application includes microcode intended to execute on a multi-threaded multi-processing network processor. The processor 12 (from FIGS. 1-2) is an example of such a network processor. The user computer system 102 includes software 103, which includes both upper-level application software 104 and lower-level software (such as an operating system or “OS”) 105. The application software 104 includes microcode build tools 106 (in the example of processor 12, a compiler and/or assembler, and a linker, which takes the compiler or assembler output on a per-ME basis and generates an image file for all specified MEs).

The application software 104 further includes a source level microcode debugger 108, which includes a simulator 110 to simulate the hardware features of the target processor 12 and possibly external hardware, such as the memory system 18 and network devices 14, 16 (shown in FIG. 1), with which the processor communicates. When the user computer system 102 is operating in a simulation mode, the simulator 110 demonstrates the functional behavior and performance characteristics of a design based on the target processor without relying on the actual hardware. The debugger 108 also includes a packet generator 111, a packet profiler 112 and various GUI components 114. Other application software may be installed on the computer system 102 as well.

Still referring to FIG. 4, the system 102 also includes several databases. The databases include debug data 116, which is “static” (as it is produced by the compiler/linker or assembler/linker at build time) and includes an operand map 118. The databases further include a simulation history 120. The simulation history 120 captures historical information that is generated over time during simulation. Also included are history marks data structure(s) 122 for recording history marks. Each data structure element or entry provides the number of the marked cycle. Further details of the history marks will be discussed later. The system 102 may be operated in standalone mode or may be coupled to a network 124 (as shown). Collectively, the application software 104 and databases 116, 120 are referred to as the development/debugger tool (indicated by reference numeral 126).

When debugging a network processor application (such as that depicted in the model of FIGS. 3A-3B), the debugger user tends to look for answers to several key questions, such as: “What processing tasks were performed on a packet, and what portion of the code represents those tasks?”; “What caused a packet-forwarding error?”; and “How much processing time was consumed by each task?”. Existing network processor application debugging tools utilize an ME- and thread-oriented view of packet processing without features to take into account the application domain. To obtain a clear picture of packet activity using such tools, much manual tracing, e.g., examining thread histories and piecing together fragments of information, is needed. In contrast, the debugger of development/debugger tool 126 is geared towards a more application friendly, “packet-centric” approach to network processor application debugging. It provides the user with an intuitive view of application and packet activity, while hiding much of the details of the underlying hardware implementation. Through the debugger GUI 114, the user gains a top-level view of a packet path (that is, the path a packet follows through the various functional units of the processor during reception, processing and transmission, if applicable) and is able to “drill down” for more specific details as desired. The tool 126 thus provides support for a packet-centric analysis based on protocol packet generation/validation, packet tracking (or tracing) and graphical views of packet status, events and dataflow, as will be described in further detail below.

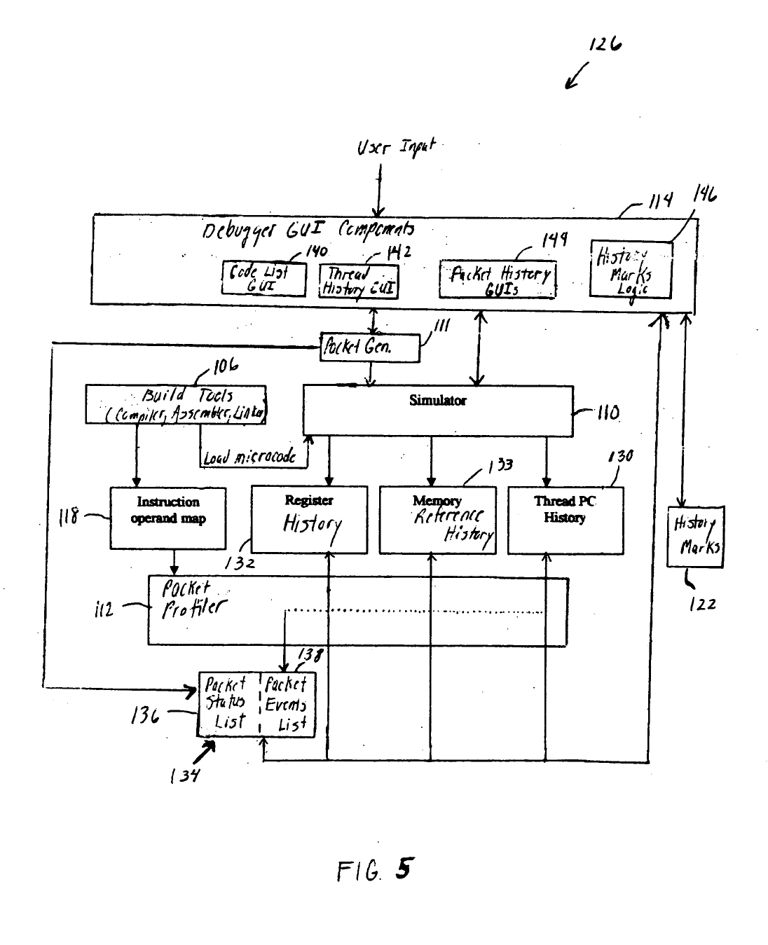

FIG. 5 shows a more detailed view of the various components of the development/debugger tool 126, in particular those components that are used to perform packet-centric debugging in a multi-threaded multi-microengine simulation environment. The components include the build tools 106, such as compiler and/or assembler, as well as linker; the simulator 110; the packet generator 111; packet profiler 112; debugger GUI 114; operand map 118; and components that make up the simulation history, including a thread (context)/PC history 130, a register history 132; a memory reference history 133; and a packet history 134. The histories 130, 132 and 133, as well as the operand map 118, exist for every ME 20 in the processor 12. The packet history 134 stores a list of packet status 136 and a list of packet events 138. The information of the packet history 134 is produced by the packet generator 111, simulator 110 and packet profiler 112, as will be described later.

The assembler and/or compiler produces the operand map 118 and, along with a linker, provides the microcode instructions to the simulator 110 for simulation. During simulation, the simulator 110 provides event notifications in the form of callbacks to the histories 130, 132, 133. In response to the callbacks, that is, for each time event, the simulator 110 can be queried for ME state information updates to be added to the simulation history 120. The ME state information includes register and memory values, as well as PC values. Other information may be included as well.

The GUI components 114 include a code list GUI 140 and a thread history GUI 142. Both of these GUIs use the simulation histories 130, 132, 133 and the code list GUI 140 uses the operand map 118. The GUI components 114 further include packet history GUIs 144, which use information from the packet history 134, as well as information from the other simulation histories and operand map 118. Also included in the GUI components 114 is history marks logic 146, to be described later with reference to FIGS. 16, 17A-17B and 18.

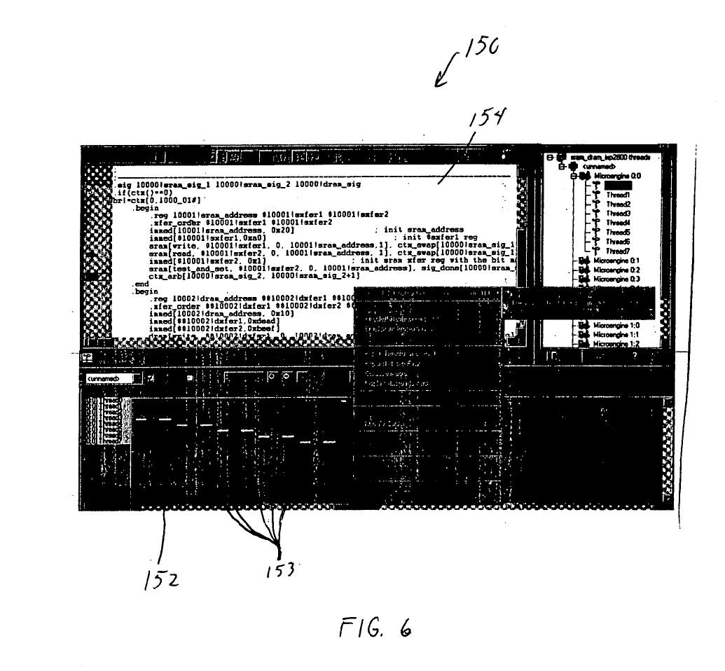

Referring to FIG. 6, an exemplary screen shot 150 shows various views including a thread history view 152 (of the thread history GUI 142) and a thread window (or code list view) 154 (of the code list GUI 140). While running a software application on the simulator 110, a history of register and memory values is saved in the simulation history 120. Using these values, the GUI components 140 and 142 present a thread history view in which the user can scroll backward and forward in the simulation history by a sliding cycle time window. The thread history view 152 thus provides a horizontally scrollable history of ME threads execution, represented by bars (“thread lines”) 153. The thread window 154 is a vertically scrollable list of instructions for a thread. The user can stop at any given cycle time of the simulation in the thread history view 152, and then switch over to the thread window 154. In the latter view, the code line that executed at the given cycle time may be marked to indicate that it is the ‘instruction of interest’.

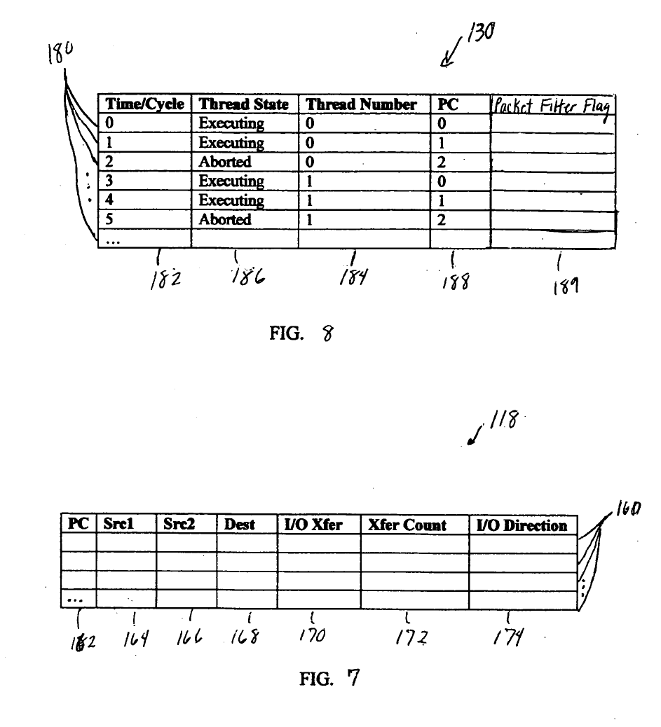

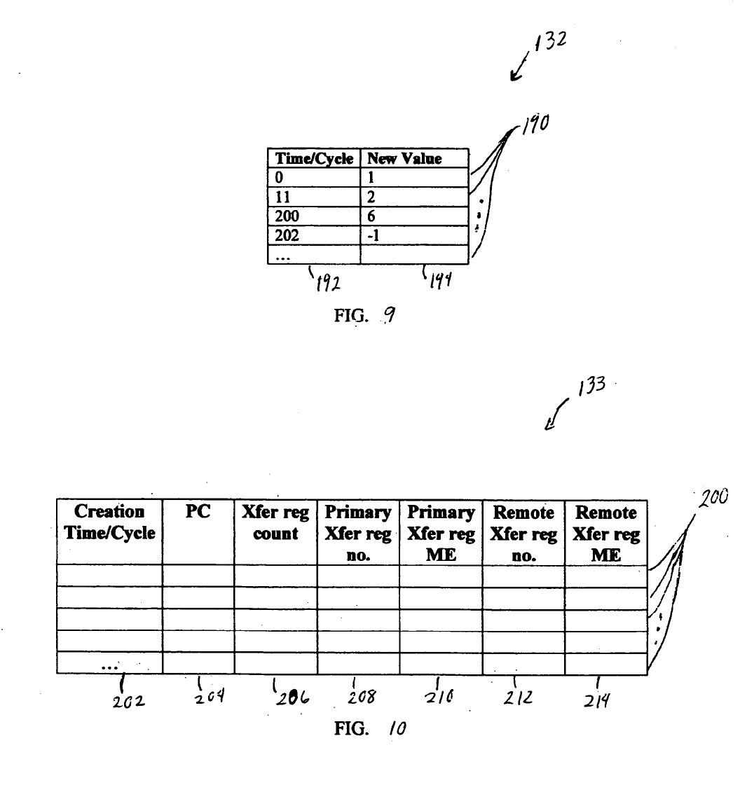

Referring to FIG. 7, an exemplary layout of the operand map 118 is shown. The operand map 118 is a table placed in the debug data by the linker. For simplicity, only a single table is shown. It will be appreciated that, although only a single table is shown, the operand map would actually include such a table (with the same format) for each ME in the processor 12. The table includes a row 160 for each instruction in the ME microcode and lists in column fields the following: PC 162; source operands including source operand SRC1 164 and source operand SRC2 166; destination operand 168: I/O transfer registers 170; I/O transfer (“Xfer”) register count 172; and I/O direction (e.g., read, write, or write/read) 174. Thus, the map can be used to do an operands lookup for a given PC.

Referring to FIG. 8, an exemplary layout of the PC history 130 is shown. The PC history 130 is a table of entries 180 corresponding to threads listed for a predetermined number of time/cycles 182. Again, although there would be table for each ME, only a single table is shown. For each time/cycle 182, the PC history 130 stores a thread (context) identified by thread number 184 and associated thread state 186. The PC history also stores a PC value 188 of the PC for that time/cycle. In one embodiment, events that occurred earlier than a user-specified history threshold are removed from the start of the list. The PC history 130 can be used to determine, for a given time/cycle, the thread number that was executing, if any, and the instruction that the thread executed and the PC value. The time/cycle 182 increases (without gaps) from earliest history cycle to most recent cycle. The thread state 186 is one of the following: executing, aborted, stalled, idle and disabled. The thread number 184 is any value from 0 through the maximum number of threads per ME. The PC value 188 is any value from 0 through the maximum number of instructions per ME.

The PC history 180 also includes a packet filter field 189 to store a flag in association with a PC value 188. Such flags are set by the packet profiler 112 during packet tracing, as will be discussed in further detail later. The flags may be initialized to a “non-relevant” value and changed to a “relevant” value during packet tracing to indicate a particular instruction's relevance to the packet being traced in simulation history.

Referring to FIG. 9, an exemplary layout of the register history 132 is shown. The register history may be a simple table as shown. In the illustrated embodiment, there is register history table for each register in an ME, and a set of such register history tables for each ME. The register history 132 records change events for each register in a ME as a list of time/value pairs 190, each including a time/cycle 192 and corresponding new value 194 (of the register). The list grows over time as register change callbacks from the processor simulator are received. In one embodiment, events that occurred earlier than a user-specified history threshold are removed from the start of the list. Given a time/cycle, it is therefore possible to lookup the value of the register at that time.

In the illustrated embodiment, and again referring back to FIG. 2, history may be collected for the following ME registers: the GPRs 56; the NN Registers 74; the SRAM and DRAM Read Xfer Registers 64; the SRAM and DRAM Write Xfer Registers 62; and Local Memory 66. In addition, history may be collected for various local CSRs.

Turning now to FIG. 10, an exemplary layout of the memory reference history 133 is shown. The memory reference history 133 may also be implemented as a simple table, as shown. Again, although only one table is shown, there would be a table for each ME. The memory reference history 133 records I/O reference events for each thread in a ME as a list ordered by creation time. The list grows over time as I/O instructions execute and callbacks from the simulator are received. Events that occurred earlier than a user-specified history threshold are removed from the start of the list. The history 133 contains a list of events 200, which are described by, among other items: Creation Time/Cycle 202; PC (of the I/O instruction) 204; number of longwords bursted in reference, i.e., the Xfer register count 206; Primary Xfer register number 208; Primary Xfer register ME 210; Remote Xfer register number 212 (meaningful for reflector instructions); and Remote Xfer register ME 214 (also meaningful for reflector instructions). Given values of the Time/Cycle 202 and PC 204, it is possible to look up the actual transfer registers used and their count for any I/O instruction.

Referring back to FIGS. 4-5, the packet generator 111 operates to source and validate packets according to user-defined specifications. The specifications may include, for example, specifications that define protocol types and traffic specifications. Packet generation enables the simulator 110 to simulate the network processor operating under a wide range of possible real-world network conditions. The packet generator 111 provides the generated packets to the simulator 110 for simulated network traffic into and out of the network processor, enabling detailed visualization of packet flow, processes, and events as the application runs. The packet generator 111 also provides output verification, including such tasks as payload validation, checksum and CRC checking, protocol conformance, packet sequencing, data rate verification and statistics.

In the illustrated embodiment, the packet profiler 112 is used to generate packet events. Packet events may be generated automatically. The automatic generation may occur in real-time and when the simulation execution has stopped (because it has been completed or paused by the user), e.g., by tracing a packet operated on by an instruction through the various memory and thread associations captured in the simulation histories 130, 132, 133. Other packet events may be generated manually with user assistance (“user-defined packet events”).

Packet events can include events related to packets being received, transmitted and processed, as well as memory events. The packet events can also correspond to dropped packets and creation of “derived” packets (e.g., for multicast), and may be used to mark that a packet processing stage has been entered. Other types of packet events, such as the queuing of a packet for non-ME processing, e.g., by the GPP 24 or a host processor, are possible as well.

In one implementation, for the case of user-defined packet events, the packet profiler 112 may be configured to perform packet tracking functions to generate/record packet events. The packet profiler 112 receives callbacks from the simulator 110. When the packet profiler 112 receives a callback from the simulator 110, it performs the packet tracking function specified by the callback. The packet tracking function may be implemented using conditional breakpointing in which a user-specified function is associated with a breakpoint, as described in co-pending U.S. patent application Ser. No. ______ (Attorney Docket No. 42P18628). For example, a user may wish to insert conditional breakpoints into the application code at key packet processing points, and associate events with these key packet processing points.

The packet tracking function may take as arguments parameters such as processor chip name, the ME number, the context number and PC, to uniquely identify a specific ME instruction. The cycle count associated with the event is the current simulation cycle count at the time the function is called. For example, a packet tracking function ‘PacketTrack_Create’ may be defined to create a new derived packet and return a packet handle that specifies the packet ID associated with the new packet.

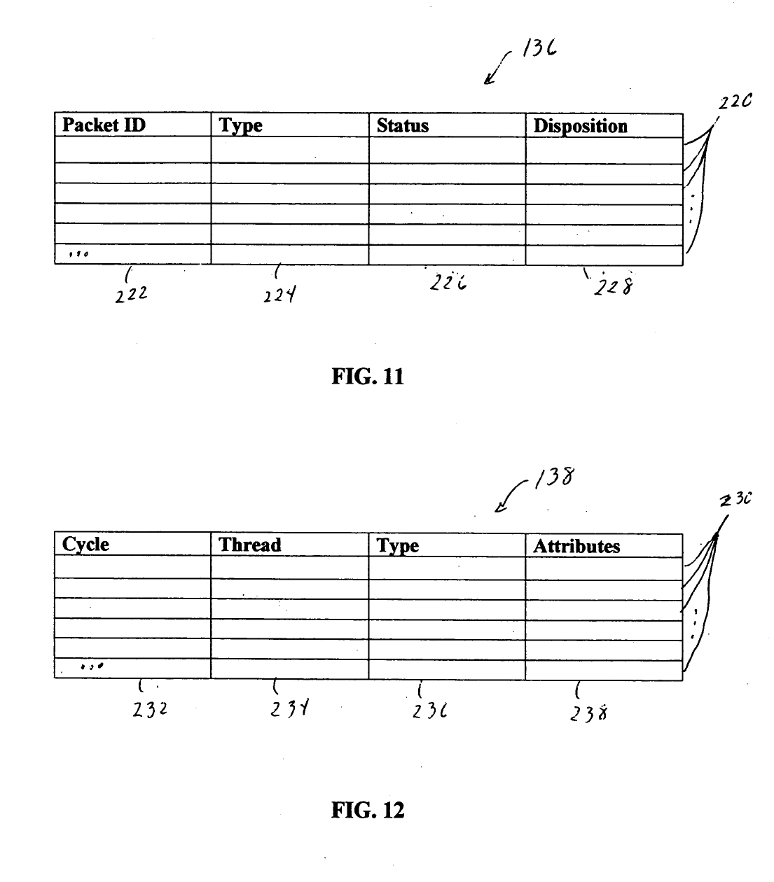

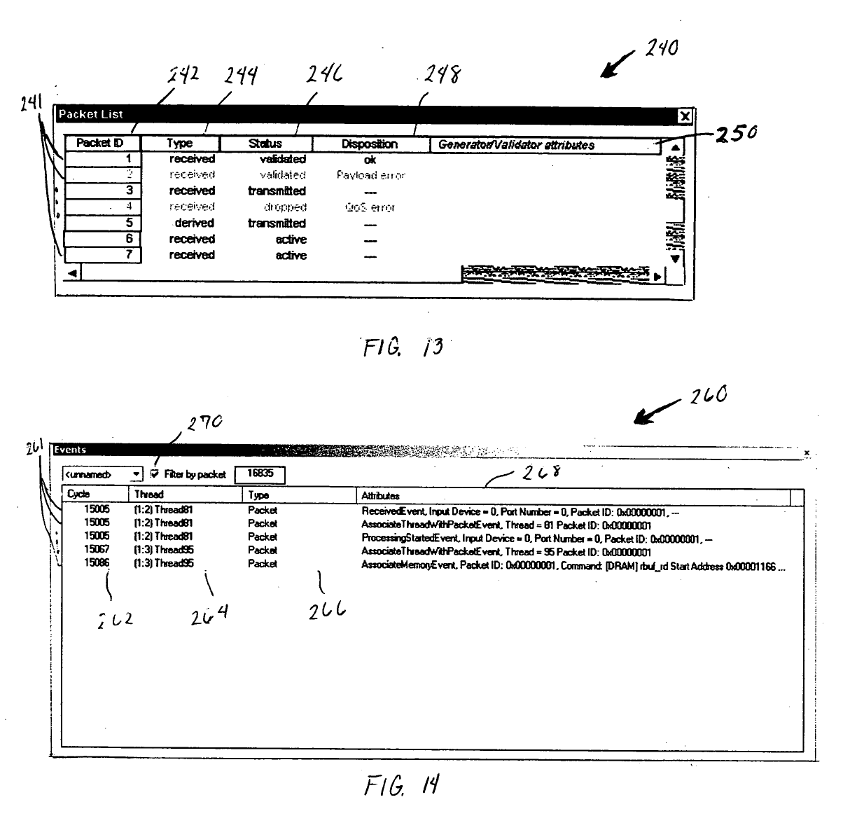

In the simulation environment of the development/debugger tool 126, certain packet events are captured and saved in the packet event list 136, and packet major status changes are placed in the packet status list 138. FIGS. 11 and 12 show example layouts for the packet status list 136 and the packet event list 138 (from FIG. 5). The packet status list 136 includes an entry 220 corresponding to each status record. Each entry includes following information: packet identifier (ID) 222; type 224; status 226 and disposition 228. The packet event list 138 includes an entry 230 for each packet event in the list. Each entry includes the following information: cycle 232; thread 234; type 236 and attributes 238. The attributes provide a description of the event, as well as other information, such as packet ID. Other information may be stored in these lists as well.

When a packet is generated by the packet generator 111, the status 226 in the packet status list 136 is set to ‘generated’. When packet data enters the receive block of the media interface (in the simulator's processor model), a ‘Receiving’ event is captured and added to the attributes 238 of the packet event list 138, and the packet status 226 of the packet status list 136 is set to ‘receiving’. Interim records of segments of packets are held until the end of the packet is received, at which point a ‘Received’ event is stored in the packet event list 138 and the packet status 226 is updated to ‘received’.

Similarly, when a packet is transmitted, the transfer of the data to the transmit block of the media interface (as modeled by the simulator) is detected. In response, a ‘Transmitting’ event is generated and added to the packet event list 138, and the packet status 226 for that packet in the packet status list 136 is changed to ‘Transmitting’. Interim records of segments of packets are held until the end of the packet is received, at which point a ‘Transmitted’ event is generated and added to the packet event list 138 and the packet status 226 is updated to ‘Transmitted’. Following transmit, when the packet generator 111 validates the packet, it sets the packet status 226 in the packet status list 136 to ‘Validated’. In the illustrated embodiment, such receive and transmit related events are generated automatically, but they could be generated manually using packing tracking functions instead.

Some or all of the packet events that occur between receive and transmit may be generated manually, and stored in the packet event list. When packet data moves to any memories of the external memory system, an ‘AssociateMemory’ event may be generated and added to the packet event list 138. When packet data is moved out of such memories, a ‘DissociateMemory’ event may be generated and added to the packet event list 138. When packet data moves into and is processed by an ME, a ‘ProcessingStarted’ event may be generated and added to the packet event list 138. When packet processing by a particular thread commences, an ‘AssociateThreadWithPacket’ event may be generated and added to the packet event list 138 as well. If code running on a thread in the simulation generates a packet, referred to as a “derived packet”, a ‘PacketDerived’ event may be generated and added to the packet event list 138. If code running on a thread simulation drops a packet, a ‘PacketDropped’ event may be generated and added to the packet event list 138.

In one implementation, the receive/transmit related packet events may be performed in real-time while the simulation is executing whereas all or some packet events occurring in between receive and transmit, e.g., ‘AssociateMemory’, may be generated while the simulation is stopped or paused. The packet profiler may perform a tracing algorithm to generate these “in between” packet events. The tracing algorithm is invoked by the user, either through a console packet tracking function, or through one of the packet history GUIs.

The tracing algorithm may trace the path of packet data backwards (or forwards) in the simulation history from a particular instruction of interest by following instruction dependencies in the PC History, marking the relevant PC values along the way by setting the flag in the Packet Filter Flag field 189. The packet profiler can then generate appropriate packet events for the packet using the simulation history information (collected in the simulation history 120) for the marked PC values. More specifically, the tracing algorithm may use a PC value to look up instruction attributes (such as type of instruction, register name, register address, and so forth) in the operand map. Based on type of instruction and the information collected in the simulation histories, the tracing algorithm can traverse forward or backward through the PC history to produce packet events for a selected packet. These events can be captured and displayed to the user in the packet history GUIs 144 “on demand”. In addition, the packet events could be added to the packet events list 138 in the packet history 134.

It will be appreciated that the type of packet events and the manner in which they are generated and handled are matters of design choice. For example, for simulator performance reasons, it may be desirable to generate certain packet events in real time during simulation and others while the simulator is paused, as was described above.

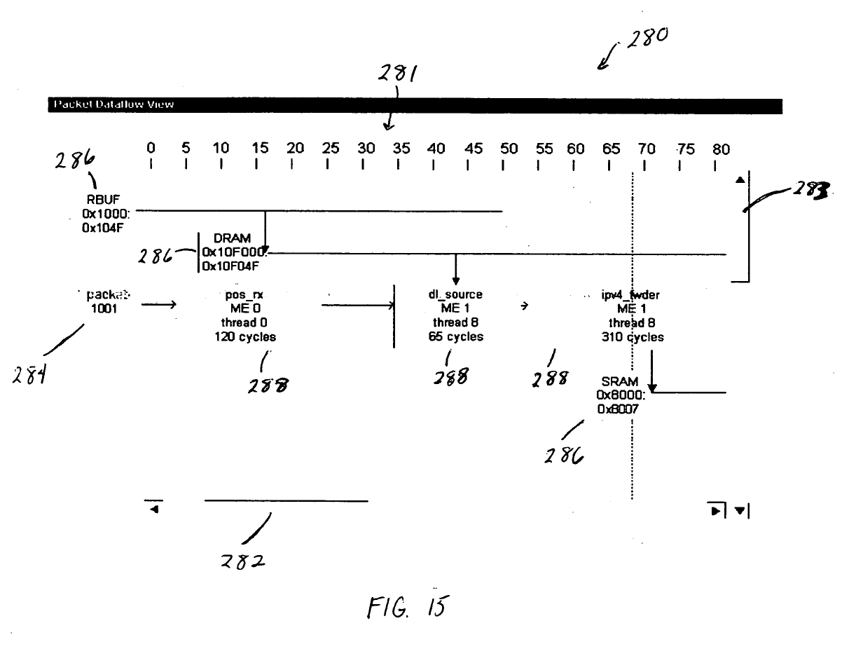

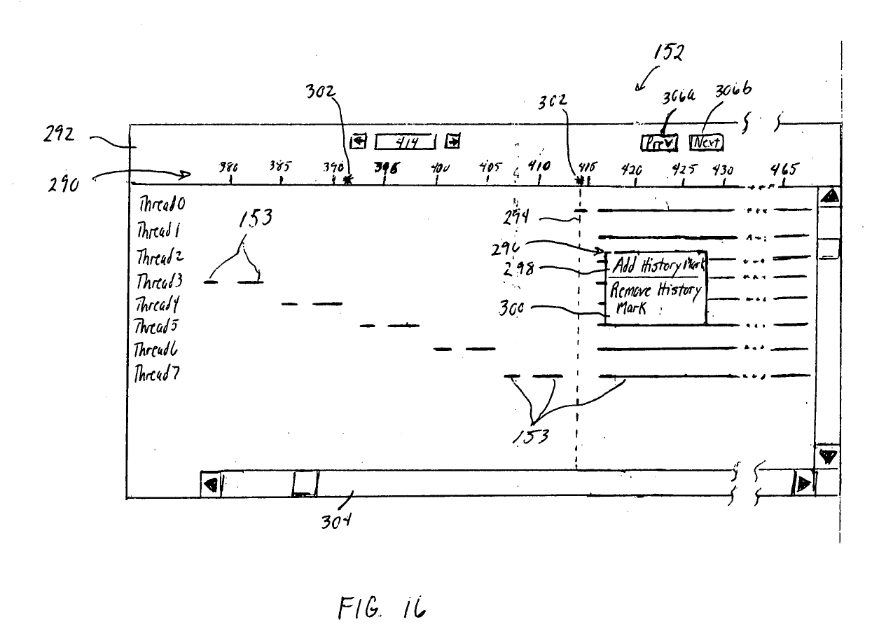

Referring to FIGS. 13-14, two exemplary packet-centric GUI views, that is, views that enable viewing of simulation history in terms of packets for a packet-focused debugging in the system 102, are shown. As shown in FIG. 13, a packet list view 240 (presented by the packet history GUIs 144, from FIG. 5) provides a vertically scrollable view of the packet status list 136. The packet list view 240 includes lines 241, each having fields 242, 244, 246, and 248 corresponding to the packet status list fields packet ID 222, type 224, status 226 and disposition 228, respectively. Other information, such as packet generator attributes (shown as column 250), may be included in this view as well. The disposition of packets is tied to the output verification provided by the packet generator, enabling the user to click on any packet to determine where an error occurred, at what point a threshold was exceeded, or otherwise pinpoint problems on a packet-by-packet basis.

The packet list view 240 may be uses as a starting point for the packet-centric debugging. It shows the state of a packet, such as whether it has been received into the processor chip, transmitted, derived from another packet, or dropped. If the packet was dropped, the reason is displayed in the disposition field 248. If the validation performed by the packet generator 111 caught an error, such as an invalid header format, the symptom information is displayed in the disposition field 248 as well. When the user sees a problem in one of the lines 241 of the packet list view 240, the user can highlight that line to flag the packet represented by that line as a “packet of interest.” At that point, the user can right-click on the packet of interest to go to the code list view of the code associated with the last major event, for example, in the case of a ‘received’ event, the first code to work on that packet, or in the case of a ‘transmitted’ event, the last code to work on the packet. The packet list view 240 thus allows the user to view all received and derived packets that are known to the simulator.

As shown in FIG. 14, a packet event view 260 (also presented by the packet history GUIs 144) provides a vertically scrollable view of the packet event list 138. In the illustrated embodiment, the packet event view 260 includes lines 261, each including fields 262, 264, 266 and 268 corresponding to the packet events list fields cycle 232, thread 234, type 236 and attributes 238, respectively. The attributes displayed in column 268 provide event details, such as type of event (e.g., ‘AssociateMemory’), packet ID and some additional information. The additional information that is provided depends on the nature of the event. In the case of an ‘AssociateMemory’ event, the additional information may describe the functional unit or shared resource involved in the event. In the case of an ‘AssociateThreadWithPacket’ event, the additional attributes information would include the number of thread. The I/O device and port numbers may be provided for other types of events, such as ‘Received’, ‘Transmitted’ and ‘ProcessingStarted’ events.

A packet may actually be in the processor for thousands of cycles. Having two major events such as ‘Transmitted’ and ‘Received’ several thousand cycles apart reduces the amount of tracing somewhat, but there is still much tracing to do in order to develop a complete picture of packet activity during simulation. The list displayed in the packet event view 260 may be a very large list of all history events, including memory reads/write, processing started on a piece of code by a thread, processing started on a microblock, packets received and transmitted, and other events. The packet event list that is displayed in this view can be filtered, e.g., by packet ID, as is shown in the figure (indicated by a selected ‘Filter by packet’ checkbox 270). It will be appreciated that other filters, e.g., memory type, microengine, and so forth, could be used. By selecting the ‘Filter by packet’ option via checkbox 270, the number of events is trimmed to show only those events involving a “packet of interest.” The user can then right-click on lines in this view to go to the exact places in the code associated with these events. This capability allows the user to verify major checkpoints along the packet's life as it is being processed by the application. If a highlighted event is associated with an ME context, then the corresponding thread window (thread window 154, shown in FIG. 6) for the context is activated automatically. Thus, a user can review the entire event history for each packet to determine where code originated, or apply packet filters to view events that occurred only when a specific packet was being processed.

Referring back to FIG. 6, as mentioned earlier, the thread history view 152 is useful for watching the behavior of threads. That window provides horizontal thread lines 153, one per thread, for up to “n×N” threads. The user can use that window to scan backward and forward in time and observe memory access events from request to completion. The user can place labels in code to signify important code points and select them for display on the thread line of the thread history window. In addition, for a selected packet of interest, the thread lines 153 presented in the thread history window may be filtered to include only those thread lines that relate to the selected packet.

Referring now to FIG. 15, the packet history GUIs 144 extend the history window concept from threads to packets by displaying packets instead of threads over simulation time in the form of a packet-centric, packet dataflow view 280. In the window of the packet dataflow view, packets are displayed horizontally along a timeline 281. The contents of the window are horizontally scrollable using a horizontal scroll bar 282 and are scrollable in a vertical direction using vertical scroll bar 283. A packet identifier label 284 is included at the beginning of the timeline to identify the packet being displayed in the view. Data structure labels 286 identifying resources, such as receive/transmit blocks (of the media interface) and memory devices (e.g., SRAMs, DRAMs, CSRs), visited by packet data of the packet are shown. The data structure labels 284 include addresses and data values of memory references, as appropriate. Also displayed are task labels 288 identifying microblock partitioning to show the flow of code for the packet. In addition to microblock partitioning, each task label 288 may include the number of the ME and thread, as well as number of cycles, involved in the processing of the packet for the displayed microblock, as shown.

The interaction of more than one packet can also be shown. The display of multiple packets may be useful in analyzing access to the shared data in critical sections. Using the packet dataflow view 280, the user can see “at a glance” the actual design running (as envisioned at the earlier stages of architecture planning and code development), with tasks and data structures prominently featured. Erroneous data in data structures, such as bad packet data, incorrect table entry, or wrong inter-thread communication are shown, thus eliminating many steps that would otherwise be required to locate and lookup data values.

All of the GUI views, thread- and packet-based alike, are cross-linked. Thus, when the window of one view scrolls, the windows of the other views scroll and center as well. If a certain packet ID is highlighted in the packet list view and the filter by packet is checked in the packet event view, the packet event view displays only those events that are associated with the packet ID highlighted in the packet list view.

Examples of debug procedures the user can exercise using these GUI views include the following. If the user starts at the packet list view, the user can highlight a line to select a packet, and then right-click to go to code associated with the status change indicated in the status field in that line or, alternatively, go to packet events view and filter by that packet. If the user is in the packet event view, the user can highlight a line to select an event, and then right-click to go to code associated with that event in the code list view or, alternatively, go to the packet data flow view to show code block and data centered (as indicated by a vertical dashed line, as shown in FIG. 15) on that event. In yet another debugging approach, the user can select a packet of interest in either the packet list or event view, and then go to the packet dataflow, where the user can scroll through the code block flow and data structures for that packet using the horizontal scroll bar.

Thus, with the development/debugger tool 126, debugging network processor application software is an efficient process, as the user can go from packet status or event to code in just a few steps. Also, users unfamiliar with the design of the application software can follow a packet dataflow view that shows the flow of code and the data operated on by a packet.

Another feature, the “history mark”, enables the debugger user to mark and navigate cycles of interest in the GUI views that present historical simulation information, such as the thread history view 152, the packet event view 260 and the packet dataflow view 280, described earlier. A history mark is a type of electronic bookmark that is used to mark points in time in the simulation history. The GUI components, responsive to user input, mark points in the simulation history, more specifically, cycles of interest, with history marks to establish a shortcut or a navigational path for visiting the marked cycles of interest. Such GUI views display information throughout a cycle range in simulation history. The thread history view 152 shows microengine threads with cycles progressing horizontally. The packet dataflow view 280 shows code flow and data structures with cycles progressing horizontally. The packet event view 260 lists memory writes and packet status change events with cycles progressing vertically. Selected cycles may be marked with history marks for each of these GUI views. While in a particular view, the user can navigate between marked cycles. When a user input indicates a move from a first marked cycle to second marked cycle, the display changes in each of the GUI views accordingly.

Each of the simulation history GUI views includes features to enable a user to add, delete and navigate history marks. The features or mechanisms available to support the history marks will vary with the nature of the GUI view, for example, a GUI view presenting horizontal cycle progression (such as the thread history view 152 and packet dataflow view 280) or a GUI view presenting a vertical cycle progression (such as the packet event view 260).

In an exemplary embodiment, and referring to FIG. 16, the thread history view 152 includes a horizontal timeline 290 (in the toolbar space 292), and a current cycle of interest indicator 294 to indicate the current cycle of interest. To set a history mark, a user selects a cycle. The GUI view cycle selection can be implemented in any number of different ways. For example, the user may ‘right-click’ on the timeline 290 to select the cycle via a pop-up menu, e.g., pop-up menu 296. In the example pop-up menu 296, the user is provided with options ‘Add history mark’ 298 and ‘Remove history mark’ 300. The user can select the ‘Add history mark’ option 298 to set the mark. At a later time, the user can select the ‘Remove history mark’ option 300 (or use some other mechanism) to remove the history mark. Other mechanisms may be used for history mark updates and navigation. For example, a history marks dialog box could be provided for this purpose. Such a dialog box could allow the user to view all history marks that have been set, and add/remove multiple history marks at a time. It could also be used for history mark navigation. As another option, it may be desirable to add or remove history marks dynamically, for example, using user-defined events and conditional breakpointing, as described earlier with reference to the packet profiler.

Once the history mark is set for a cycle, the marked cycle is visually represented by the GUI view with some type of indicator or icon 302, shown in the illustration simply as an asterisk (“*”) 302, when the marked cycle is within a range of cycles that are visible to the user (that is, within in the window of display). The history mark indicator could take some other form. For example, the history mark could be visually represented by a bookmark icon. In yet another example, the history mark indicator could be a line at the given cycle. If the history is horizontally scrolling, as it is in the thread history view, the line would be a vertical line. It may be desirable to distinguish the vertical line for the history mark indicator from the vertical line used as the current cycle of interest indicator in some manner, by using different colors or types of lines (one dotted, the other solid or dashed), for example.

The illustrated example shows that the user has set a history mark at cycle 392 and the current cycle of interest, cycle 414. Other marked cycles not visible to the user may be displayed to the user by navigating the marks or scrolling the contents of the view window via the horizontal scroll bar 304. The user can select the history mark indicators 302 to move from one to another, or can use buttons 306a, 306b, to be taken to a previous marked cycle as the current cycle of interest or to be taken to the next marked cycle as the current cycle of interest, respectively. A menu could be provided to perform the same activity as the buttons 306a, 306b.

It will be appreciated that other horizontally-scrolling views, such as the packet dataflow view 280, can be configured with the same or similar features to support the use of history marks. In the packet dataflow view 280, the user chooses the cycle of interest by right-clicking on a data structure label or code block task label. As discussed earlier, the user can select certain information to be displayed in the labels, such as local memory values. The user can also zoom hierarchically into a code block for a more detailed code flow. The user may set history marks at the different levels of the view. The history mark data structures or other data structures can be used to keep notes on the state of the data structure and task labels in the packet dataflow view for the marked cycles.

A GUI view with history that is vertically scrolling, for example, the packet event view 260, can be configured with features to enable the user to add, remove and navigate the history marks as well. In such a view, the user can choose a cycle to be marked by selecting a line, e.g., by right-clicking on the line, or using some other mechanism such as a dialog box selection mechanism or command line interface command, as discussed above in connection with the thread history and packet dataflow views. For example, in the packet event view, a history mark may be added by right-clicking on a line (in the case of the packet event view, the line is an event) to bring up a menu, and making the appropriate menu selection. A margin indicator (which may be the same type of mark indicator as mark indicator 302, for example, a “*”) may be used to indicate that the line is set with a history mark. The user can right-click on the margin indicators to move backward or forward through history marks sequentially, or toggle between the last two visited. In addition, the GUI view may provide a history marks filtering option to enable the user to filter the history to show only lines corresponding to marked cycles.

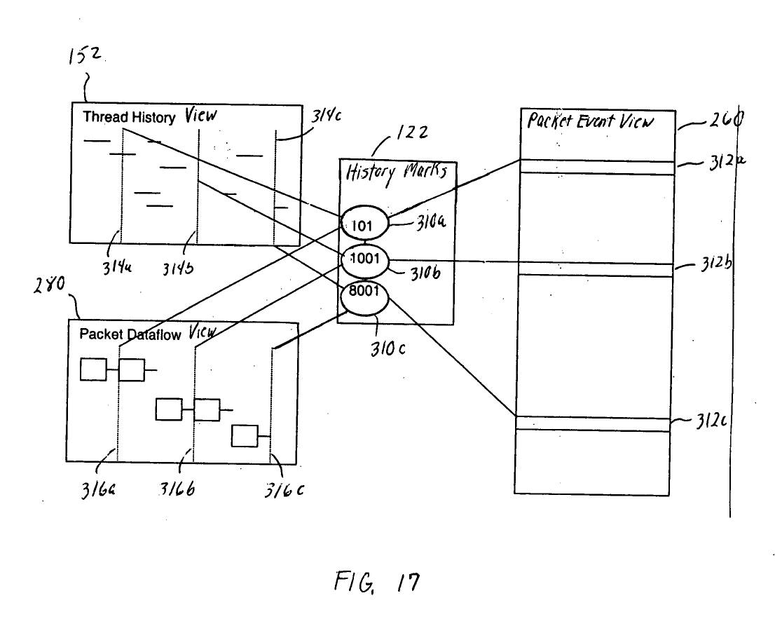

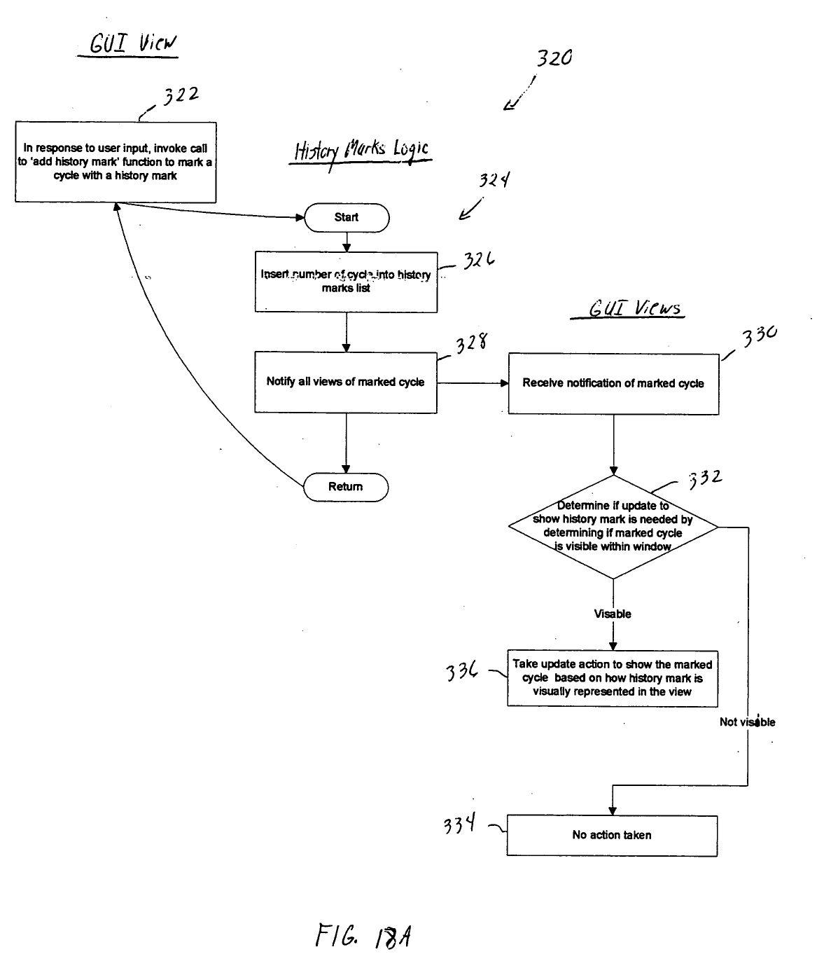

FIG. 17 shows the relationship between simulation history GUI views 152, 260, 280 and the contents of the history marks data structure 122. In this example, the history marks data structure 122 includes history marks 310a, 310b, 310c that have been set for three different cycles, shown as cycle 101, cycle 1001 and cycle 8001, respectively. The history marks data structure 122 may be a list, such as a linked list, a stack, or some other type of data structure. The history marks 310a, 310b, 310c correspond to different entries or elements in the data structure. In the packet event view 260, the history marks 310a, 310b, 310c correspond to events (packet event list lines or rows) 312a, 312b, 312c, respectively. In the thread history view 152, the history marks 310a, 310b, 310c correspond to horizontal timeline points 314a, 314b, 314c, respectively. In the packet dataflow view 280, the history marks 310a, 310b, 310c correspond to horizontal timeline points 316a, 316b, 316c, respectively. In the views 152, 280, the horizontal timeline points are those of the cycle numbers provided in the corresponding history marks.

Multiple window views, such as GUI views 152, 260, 280, show different aspects of the data when cycles are returned to for a history mark. For example, the thread history view 152 shows threads active on a packet of interest at the history mark cycle, whereas the packet dataflow view 280 shows specific data or zoom views remembered for the history mark cycle. Thus, the debug process is greatly accelerated, because the user can toggle views from widely different points in simulation. Cycles can be marked, left, and quickly revisited. The simulation history GUI views are synchronized so that they all switch back to the same cycle when a history mark is selected from any of them.

When the history mark is set, display and information options may be saved with the history mark (or in a separate data structure). The thread history and packet event view filters and display options, for example, may be saved with the history mark. Zoom selections, data display selections and memory reference display selections for the packet dataflow view may be saved with the history mark. Thus, when the user uses one GUI view to visit a marked cycle, the filters and options for the various history GUI views appropriate for those history GUI views go into effect for the cycle of the history mark, and the display reverts to what was displayed when the user set the mark. At this time the user may change the display options, and these are now saved as the new options for the mark.

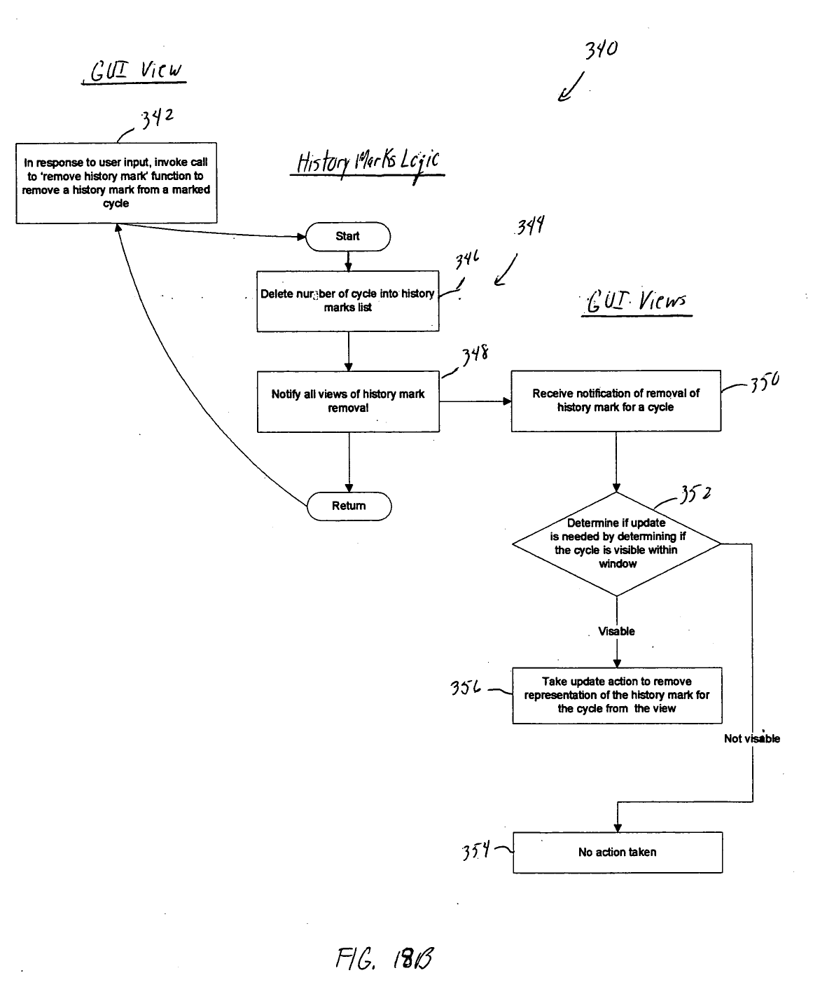

Referring back to FIG. 5, the GUI components 114 includes history marks logic 146 that interacts with the GUI views and the history marks data structure 122 when history marks updates or navigation are requested by the user (via one of the GUI views). The operation of the history marks logic 146, in conjunction with the GUI views, in adding and deleting history marks is described below with reference to FIGS. 18A-18B.

Referring to FIG. 18A, an overview of processing to support the creation of a history mark (processing overview 320) is shown. When a GUI view receives a request (based on user input) that a given cycle be marked with a history mark, the GUI view calls 322 a function (‘add history mark’ function 324) to mark the cycle with a history mark. Once called, the ‘add history mark’ function 324 inserts 326 the number of the cycle into a history marks list and notifies 328 all GUI views of the marked cycle. In response to receiving 330 such notification, each GUI view performs the following. The GUI view determines 332 if an update to show the history mark is needed by determining if the marked cycle is visible within the window. If the marked cycle is not visible, no action is taken (as indicated by reference numeral 334). If the marked cycle is visible, the GUI view takes 336 appropriate update action to show the marked cycle. The type of action taken is based on how the history mark is visually represented in the view.

Referring to FIG. 18B, an overview of processing to support the removal of a history mark (processing overview 340) is shown. When a GUI view receives a request (based on user input) that a history mark for a given marked cycle is to be removed, the GUI view calls 342 a second function (a ‘remove history mark’ function 344) to remove the history mark from that cycle. Once called, the ‘remove history mark’ function 344 removes 346 the number of the cycle from the history marks list and notifies 348 all GUI views of the history mark removal. In response to receiving 350 such notification, each GUI view performs as follows. The GUI view determines 352 if an update to show the history mark is needed by determining if the cycle in question is visible within the window. If the cycle is not visible, no update activity is necessary (as indicated by reference numeral 354). If the marked cycle is visible, the GUI view updates 356 itself to remove the representation of the history mark for the cycle. Again, the type of action taken is based on how a history mark is visually represented in the view.

It may be possible to set history marks in the non-cycle-oriented GUI views such as the code list view 154 and the packet list view 240 as well. Since the lines in these views do not correspond to cycles, any visual representation of a history mark should take into account the possibility that a line in the view may correspond to more than one history mark. For example, a line in the code list view may be identified as having a history mark associated with it. Consequently, prior to removing that history mark (and any visual indicator of that history mark), the code list view needs to ensure that the line of code was not executed at any other marked cycles.

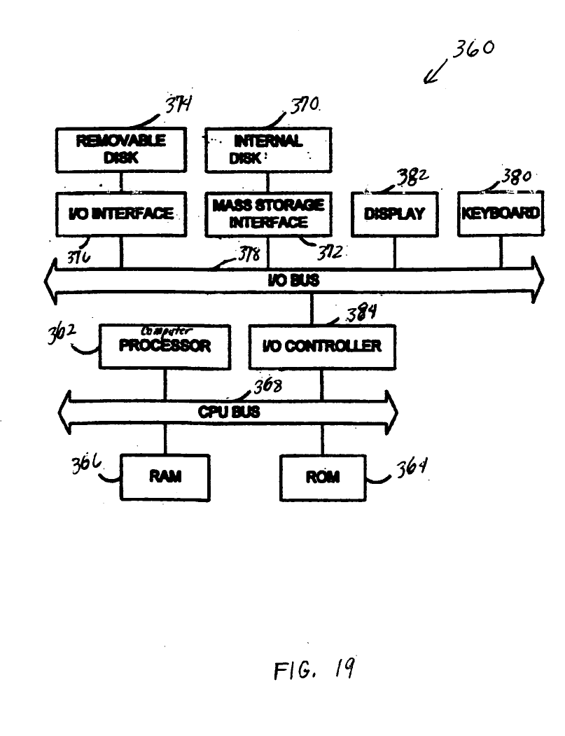

Referring to FIG. 19, an exemplary computer system 360 suitable for use as system 102 as a development/debugger system and, therefore, for supporting the upper-level application software 104 of the development/debugger tool 126, including the debugger software, and any other processes used or invoked by such software), is shown. The upper-level application software may be implemented in a computer program product tangibly embodied in a machine-readable storage device for execution by a computer processor 362; and methods of the tool 126 may be performed by the computer processor 362 executing a program to perform functions of the tool 126 by operating on input data and generating output.

Suitable processors include, by way of example, both general and special purpose microprocessors. Generally, the processor 306 will receive instructions and data from a read-only memory (ROM) 364 and/or a random access memory (RAM) 366 through a CPU bus 368. A computer can generally also receive programs and data from a storage medium such as an internal disk 370 operating through a mass storage interface 372 or a removable disk 374 operating through an I/O interface 376. The flow of data over an I/O bus 378 to and from devices 370, 374, (as well as input device 380, and output device 382) and the processor 362 and memory 366, 364 is controlled by an I/O controller 384. User input is obtained through the input device 380, which can be a keyboard (as shown), mouse, stylus, microphone, trackball, touch-sensitive screen, or other input device. These elements will be found in a conventional desktop computer as well as other computers suitable for executing computer programs implementing the methods described here, which may be used in conjunction with output device 382, which can be any display device (as shown), or other raster output device capable of producing color or gray scale pixels on paper, film, display screen, or other output medium.

Storage devices suitable for tangibly embodying computer program instructions include all forms of non-volatile memory, including by way of example semiconductor memory devices, such as EPROM, EEPROM, and flash memory devices; magnetic disks such as internal hard disks 370 and removable disks 374; magneto-optical disks; and CD-ROM disks. Any of the foregoing may be supplemented by, or incorporated in, specially-designed ASICs (application-specific integrated circuits).

Typically, the application software of the tool 126 and other related processes reside on the internal disk 370. These processes are executed by the processor 362 in response to a user request to the computer system's operating system in the lower-level software 105 after being loaded into memory. Any files or records produced by these processes may be retrieved from a mass storage device such as the internal disk 370 or other local memory, such as RAM 366 or ROM 364.

The system 102 illustrates a system configuration in which the application software 104 is installed on a single stand-alone or networked computer system for local user access. In an alternative configuration, e.g., the software or portions of the software may be installed on a file server to which the system 102 is connected by a network, and the user of the system accesses the software over the network.

Other embodiments are within the scope of the following claims.

1. A method comprising:
providing a graphical user interface (GUI) to a simulation history;
causing marks to be set at points in time in the simulation history; and
enabling user navigation of the marks from the GUI.

2. The method of claim 1 wherein the simulation history is produced by a simulation that models a network processor and executes application software developed for the network processor.

3. The method of claim 2 wherein the GUI comprises one or more GUI views and wherein causing marks to be set at points in time in the simulation history comprises enabling a user to set the marks using one of the one or more GUI views.

4. The method of claim 3 wherein each point corresponds to an execution cycle.

5. The method of claim 4 wherein causing marks to be set at points in time in the simulation history further comprises:
receiving input from a user indicating the execution cycle; and
causing a number for the execution cycle to be stored in a data structure.

6. The method of claim 5 wherein causing the execution cycle number to be stored in the data structure comprises:
calling a function that, when called, adds the execution cycle number to the data structure and notifies others of the one or more GUI views to perform a window update to show a mark indicator for the mark set at the execution cycle number that was added to the data structure, if the execution cycle is visible in the window at the time of notification.

7. The method of claim 6 wherein the one or more GUI views comprises at least one view in which progression of execution cycles in the simulation history is displayed along a horizontal timeline.

8. The method of claim 7 wherein the at least one view comprises a thread history view to show activity of one or more execution threads of the network processor.

9. The method of claim 7 wherein the at least one view comprises a packet dataflow view to show packet activity for packets operated on by the network processor during the simulation.

10. The method of claim 7 wherein the mark indicator in the at least one view is an icon.

11. The method of claim 6 wherein the one or more GUI views comprises at least one view in which progression of execution cycles in the simulation history is displayed in vertically scrollable lines.

12. The method of claim 11 wherein the at least one view comprises a packet event view in which each of the lines corresponds to a different event occurring at a different execution cycle.

13. The method of claim 4 wherein views in the one or more GUI views are synchronized so that the selection of one of the marks in one of the views causes the execution cycle at which the mark is set to be displayed as a current execution cycle of interest in each of the views.

14. The method of claim 1, further comprising:
executing application software during a simulation that models a network processor for which the application software was developed; and
capturing results of the simulation to produce the simulation history.

15. An article comprising:
a storage medium having stored thereon instructions that when executed by a machine result in the following:
providing a GUI interface to a simulation history;
causing marks to be set at points in time in the simulation history; and
enabling user navigation of the marks from the GUI.

16. The article of claim 15 wherein the simulation history is produced by a simulation that models a network processor and executes application software developed for the network processor.

17. The article of claim 16 wherein the GUI comprises one or more GUI views and wherein causing marks to be set at points in time in the simulation history comprises enabling a user to set the marks using one of the one or more GUI views.

18. The article of claim 17 wherein each point corresponds to an execution cycle.

19. The article of claim 18 wherein causing marks to be set at points in time in the simulation history further comprises:
receiving input from a user indicating the execution cycle; and
causing a number for the execution cycle to be stored in a data structure.

20. The article of claim 19 wherein causing the execution cycle number to be stored in the data structure comprises:
calling a function that, when called, adds the execution cycle number to the data structure and notifies others of the one or more GUI views to perform a window update to show a mark indicator for the mark set at the execution cycle number that was added to the data structure, if the execution cycle is visible in the window at the time of notification.

21. The article of claim 20 wherein the one or more GUI views comprises at least one view in which progression of execution cycles in the simulation history is displayed along a horizontal timeline.

22. The article of claim 21 wherein the at least one view comprises a thread history view to show activity of one or more execution threads of the network processor.

23. The article of claim 21 wherein the at least one view comprises a packet dataflow view to show packet activity for packets operated on by the network processor during the simulation.

24. The article of claim 21 wherein the mark indicator in the at least one view is an icon.

25. The article of claim 20 wherein the one or more GUI views comprises at least one view in which progression of execution cycles in the simulation history is displayed in vertically scrollable lines.

26. The article of claim 25 wherein the at least one view comprises a packet event view in which each of the lines corresponds to a different event occurring at a different execution cycle.

27. The article of claim 18 wherein views in the one or more GUI views are synchronized so that the selection of one of the marks in one of the views causes the execution cycle at which the mark is set to be displayed as a current execution cycle of interest in each of the views.

28. The article of claim 15 wherein the instructions comprise instructions that when executed by a machine result in the following:
executing application software during a simulation that models a network processor for which the application software was developed; and
capturing results of the simulation to produce the simulation history.

29. A user interface comprising:
a debugger user interface to provide a GUI to a simulation history;
wherein the GUI is usable to set marks at points in time in the simulation history; and
wherein the GUI is usable to navigate the marks.

30. The user interface of claim 29 wherein the simulation history is produced by a simulation that models a network processor and executes application software developed for the network processor.

31. The user interface of claim 30 wherein the GUI comprises one or more GUI views and wherein at least one of the one or more GUI views is usable to set the marks.

32. The user interface of claim 31 wherein each point corresponds to an execution cycle.

33. The user interface of claim 32 wherein the GUI is usable to receive input from a user indicating the execution cycle and to cause a number for the execution cycle to be stored in a data structure.

34. The user interface of claim 33 wherein the debugger user interface includes logic to add the execution cycle number to the history data structure and to notify others of the one or more GUI views to perform a window update to show a mark indicator for the mark set at the execution cycle number that was added to the data structure, if the execution cycle is visible in the window at the time of notification.

35. The user interface of claim 34 wherein the one or more GUI views comprises at least one view in which progression of execution cycles in the simulation history is displayed along a horizontal timeline.

36. The user interface of claim 35 wherein the at least one view comprises a thread history view to show activity of one or more execution threads of the network processor.

37. The user interface of claim 35 wherein the at least one view comprises a packet dataflow view to show packet activity for packets operated on by the network processor during the simulation.

38. The user interface of claim 35 wherein the mark indicator in the at least one view is an icon.

39. The user interface of claim 34 wherein the one or more GUI views comprises at least one view in which progression of execution cycles in the simulation history is displayed in vertically scrollable lines.

40. The user interface of claim 39 wherein the at least one view comprises a packet event view in which each of the lines corresponds to a different event occurring at a different execution cycle.

41. The user interface of claim 32 wherein views in the one or more GUI views are synchronized so that the selection of one of the marks in one of the views causes the execution cycle at which the mark is set to be displayed as a current execution cycle of interest in each of the views.

42. A development/debugger tool comprising:
software to generate application code for a target processor;
a simulator to execute the application code during a simulation that models the target processor;
a GUI to interface to the simulation history; and
wherein the GUI is usable to enable a user to set marks in time in the simulation history and navigate the marks from the GUI.

43. The development/debugger tool of claim 42 wherein the GUI is usable to provide multiple views including at least one view in which progression of execution cycles in the simulation history is displayed along a horizontal timeline and at least one other view in which progression of execution cycles in the simulation history is displayed in vertically scrollable lines.
